(19) United States
(12) Patent Application Publication
(10) Pub. No.: US 2026/0110330 A1
(43) Pub. Date: Apr. 23, 2026

(54) SLIDING DEVICE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Eiji KOJIMA, Nisshin-shi (JP); Nobuyuki OTAKE, Nisshin-shi (JP)

(21) Appl. No.: 19/276,337

(22) Filed: Jul. 22, 2025

(30) Foreign Application Priority Data
Oct. 22, 2024 (JP) 2024-186021

(51) Int. Cl. F16C 33/10; C10M 103/04; F16C 29/02; F16C 33/12

(52) U.S. Cl. CPC F16C 33/1095; C10M 103/04; F16C 29/02; F16C 33/121

(57) ABSTRACT

A sliding device includes a first sliding body and a second sliding body. A first sliding face that is a surface of the first sliding body and a second sliding face that is a surface of the second sliding body slide against each other in a hydrogen atmosphere. The first sliding body includes a first solid lubricant film forming the first sliding face. The second sliding body includes a second solid lubricant film forming the second sliding face. The first solid lubricant film is made of a material having an amorphous structure. The second solid lubricant film is made of a material having a layered structure.

### CROSS REFERENCE TO RELATED APPLICATION

This application is based on and incorporates herein by reference Japanese Patent Application No. 2024-186021 filed on Oct. 22, 2024.

### TECHNICAL FIELD

The present disclosure relates to a sliding device used in a hydrogen atmosphere.

### BACKGROUND

A sliding member is used in a hydrogen environment.

### SUMMARY

According to at least one embodiment of the present disclosure, a sliding device includes a first sliding body and a second sliding body. The first sliding body has a surface as a first sliding face. The second sliding body has a surface as a second sliding face. The first sliding face and the second sliding face are configured to slide against each other in a hydrogen atmosphere. The first sliding body includes a first solid lubricant film forming the first sliding face. The second sliding body includes a second solid lubricant film forming the second sliding face. The first solid lubricant film is made of a material having an amorphous structure. The second solid lubricant film is made of a material having a layered structure.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a cross-sectional view showing a schematic configuration of a sliding device according to a first embodiment of the present disclosure.

FIG. 2 is a graph showing a comparison of wear rates in a working example and a comparative example.

FIG. 3 is a cross-sectional view showing a schematic configuration of a sliding device according to a second embodiment of the present disclosure.

### DETAILED DESCRIPTIONS

According to a reference example, a sliding member is used in a hydrogen atmosphere, more specifically, in a state exposed to a gas atmosphere containing hydrogen. The sliding member for a hydrogen environment includes a surface at least part of which is covered by a coating layer made of diamond-like carbon. The coating layer contains an element (e.g., nitrogen or fluorine) whose bond energy with carbon is greater than a bond energy between carbon and hydrogen.

However, even in a technology of the reference example, it is difficult to form a stable sliding face, and a resulting solid lubricity, i.e., a wear resistance is limited. In contrast to the reference example, according to the present disclosure, for example, a sliding device is capable of achieving a stable wear resistance in a hydrogen atmosphere.

According to at least one embodiment of the present disclosure, a sliding device includes a first sliding body and a second sliding body. The first sliding body has a surface as a first sliding face. The second sliding body has a surface as a second sliding face. The first sliding face and the second sliding face are configured to slide against each other in a hydrogen atmosphere. The first sliding body includes a first solid lubricant film forming the first sliding face. The second sliding body includes a second solid lubricant film forming the second sliding face. The first solid lubricant film is made of a material having an amorphous structure. The second solid lubricant film is made of a material having a layered structure.

### EMBODIMENTS

The embodiments of the present disclosure will be described below with reference to the drawings. In the following embodiments, portions that are the same as or equivalent to those described in a preceding embodiment are denoted by the same reference numerals, and a description of the same or equivalent portions may be omitted. When only some of the configuration elements are described in the embodiment, the remaining configuration elements can be referred from those described in the preceding embodiment. The following embodiments may be partially combined with each other even if such a combination is not explicitly described as long as there is no disadvantage with respect to such a combination.

It should be noted that the following embodiments, their variations, and the accompanying drawings are simplified or schematically presented to concisely explain the contents of the present disclosure and do not limit the scope of the present disclosure. Therefore, it is needless to say that the descriptions in the drawings may not necessarily correspond exactly to the specific device configurations that are actually manufactured and sold. In other words, unless explicitly limited by the applicants during the prosecution of the present application, the present disclosure should not be construed as being limited by the descriptions in the drawings or the configurations, functions, or operations described hereinafter.

### First Embodiment

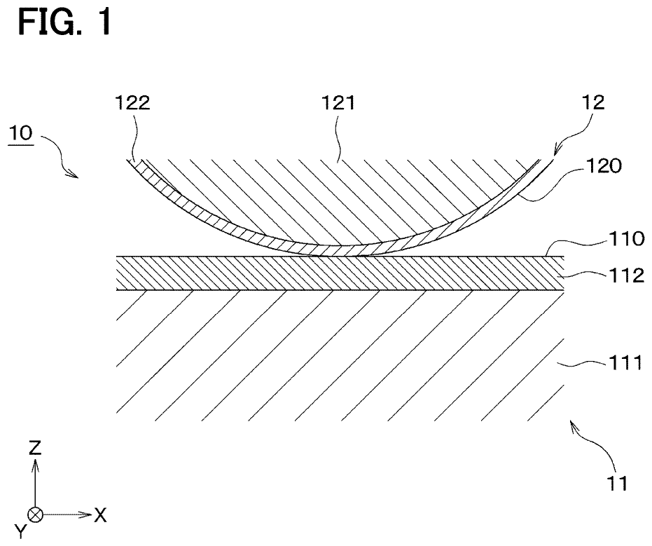

Hereinafter, a configuration of a sliding device 10 according to a first embodiment of the present disclosure will be described with reference to FIG. 1. As shown in FIG. 1, the sliding device 10 of the present embodiment includes a first sliding body 11 and a second sliding body 12, on a premise that the first sliding body 11 and the second sliding body 12 slide against each other in a hydrogen atmosphere. The “hydrogen atmosphere” refers to an atmosphere containing hydrogen. Typically, the hydrogen atmosphere is a gaseous atmosphere containing hydrogen gas.

To simplify illustration and description, a right-handed XYZ coordinate system as shown in FIG. 1 is adopted. Here, a Z-axis direction is referred to as a “height direction”, and an arbitrary direction within the XY plane is referred to as an “in-plane direction”. In the present embodiment, the first sliding body 11 has a plate shape extending along the in-plane direction. On the other hand, the second sliding body 12 has a spherical shape, or a cylindrical or hollow cylindrical shape having a central axis parallel to a Y axis in FIG. 1. Additionally, in the sliding device 10, the first sliding body 11 and the second sliding body 12 are arranged in the height direction and slide against each other in the in-plane direction.

The first sliding body 11 includes a first sliding face 110 that is a surface facing the second sliding body 12, i.e., a sliding face. In the present embodiment, the first sliding face 110 has a flat shape extending in the in-plane direction. Specifically, the first sliding body 11 includes a first base 111 and a first solid lubricant film 112.

The first base 111 has a structure in which a base film made of titanium nitride is deposited on a surface of a bearing steel such as SUJ2. The first solid lubricant film 112 is provided on the first sliding body 11 so as to cover the first base 111. Specifically, the first solid lubricant film 112 is deposited on the above-described base film deposited on the surface of the first base 111. The first solid lubricant film 112 constitutes an outermost layer of the first sliding body 11, i.e., the first sliding face 110. The first solid lubricant film 112 is made of transition metal chalcogenide. In the present embodiment, the first solid lubricant film 112 has a structure as a molybdenum disulfide film.

The second sliding body 12 includes the second sliding face 120 that is a surface facing the first sliding body 11, i.e., a sliding face. In the present embodiment, the second sliding body 12 has a spherical or cylindrical shape. Specifically, the second sliding body 12 includes the second base 121 and the second solid lubricant film 122.

The second base 121 has a structure in which a base film made of titanium nitride is deposited on a surface of a bearing steel such as SUJ2. The second solid lubricant film 122 is provided on the second sliding body 12 so as to cover the second base 121. Specifically, the second solid lubricant film 122 is coated on the above-described base film deposited on the surface of the second base 121. The second solid lubricant film 122 constitutes an outermost layer of the second sliding body 12, i.e., the second sliding face 120. The second solid lubricant film 122 is made of transition metal chalcogenide. In the present embodiment, the second solid lubricant film 122 has a structure as a molybdenum disulfide film.

In the present embodiment, the first solid lubricant film 112 includes an amorphous structure. A transition metal chalcogenide film with the amorphous structure can be deposited by a well-known method such as sputtering.

In contrast, the second solid lubricant film 122 has a layered structure. The “layered structure” means a structure in which a c-axis of a crystal structure is along a certain direction, and is also referred to as a “two-dimensional crystal structure.” Specifically, the second solid lubricant film 122 is deposited so that the c-axis of the second solid lubricant film 122 is perpendicular to the second sliding face 120. A substance or material having such a layered structure may be referred to as a “layered substance” or “two-dimensional material.” The transition metal chalcogenide film having the layered structure can be deposited by a well-known method such as ALD. ALD is an abbreviation for Atomic Layer Deposition.

Hereinafter, the wear resistance performance achieved by the sliding device 10 according to the present embodiment will be described using a working example and a comparative example.

When the sliding device 10 having the above structure is exposed to a hydrogen atmosphere, hydrogen termination occurs on the first sliding face 110 which is an outer surface of the first solid lubricant film 112 having the amorphous structure. The second sliding face 120 is an outer surface of the second solid lubricant film 122, two-dimensionally orienting due to the layered structure. Since the second sliding face 120 and the hydrogen terminated first sliding face 110 slide against each other, low wear can be achieved.

In contrast, in a structure where both of the first solid lubricant film 112 and the second solid lubricant film 122 are oriented two-dimensionally, such hydrogen terminated face does not exist in sliding faces. Since interlayer couplings generated between the layered substances facing each other, a friction between the layered substances is expected to be greater than the structure of the present embodiment. Further, in a structure where both of the first solid lubricant film 112 and the second solid lubricant film 122 have the amorphous structure, both of the first sliding face 110 and the second sliding face 120 become hydrogen terminated faces, and a lubricant surface obtained by two-dimensional orientation no longer exists in the sliding surfaces. Therefore, the friction between the sliding surfaces is expected to be greater than the structure according to the present embodiment.

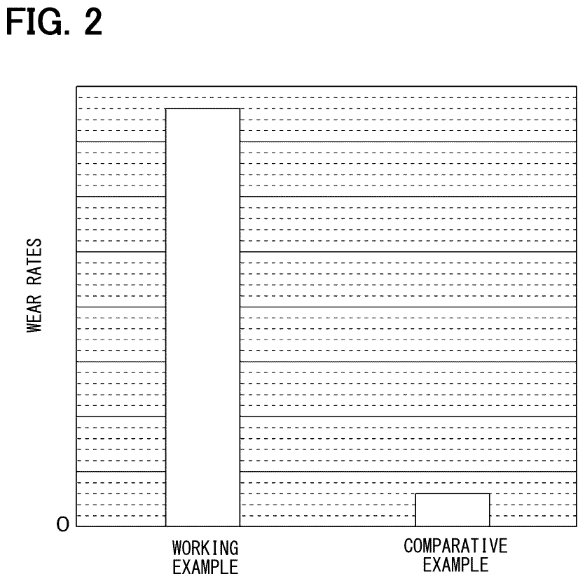

FIG. 2 is a graph comparing wear rates of a comparative example and a working example. The working example corresponds to the present embodiment. In the comparative example, neither the first solid lubricant film 112 nor the second solid lubricant film 122 is provided. In other words, the first base 111 and the second base 121 slide against each other. Here, the second sliding body 12 is assumed to be spherical. A wear rate of the second sliding body 12 is expressed in units of mm³/Nm. As illustrated in FIG. 2, the wear rate of the working example was significantly lower than that of the comparative example.

As described above, of the first solid lubricant film 112 and the second solid lubricant film 122 of the present embodiment, which slide against each other, one sliding face has the amorphous structure and the other sliding face has the layered structure, i.e., a non-amorphous two-dimensional structure. Therefore, a stable wear resistance can be achieved.

### Second Embodiment

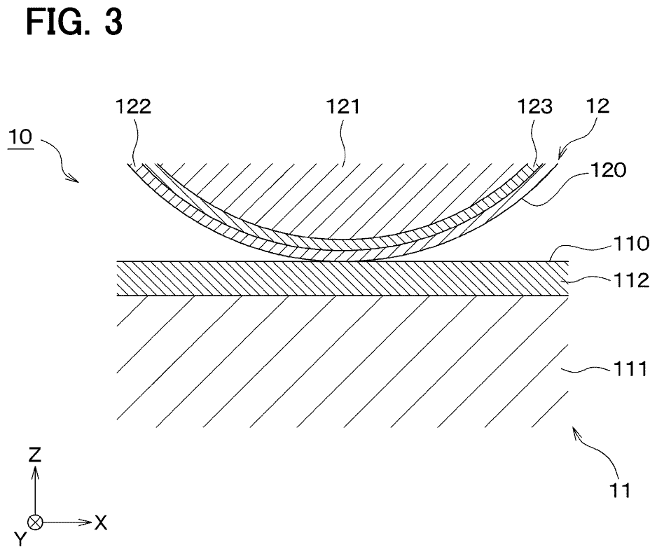

Hereinafter, a second embodiment will be described with reference to FIG. 3. In the following descriptions of the second embodiment, portions different from those of the first embodiment will be mainly described. In the first embodiment and the second embodiment, portions that are the same or equivalent to each other are assigned the same reference numerals. Therefore, in the following descriptions of the second embodiment, the descriptions of the first embodiment may be appropriately incorporated for the components having the same reference numerals as those of the first embodiment, as long as there is no technical contradiction or no special additional description.

As shown in FIG. 3, in the present embodiment, a second sliding body 12 includes an intermediate layer 123 in addition to a second base 121 and a second solid lubricant film 122. In other words, the second sliding body 12 has a structure in which materials are deposited in the following order: the second base 121, the intermediate layer 123 which is provided to cover the second base 121, and the second solid lubricant film 122 which is provided to cover the intermediate layer 123.

The second solid lubricant film 122 is constituted of, as well as in the first embodiment, a transition metal chalcogenide, i.e., molybdenum disulfide. Additionally, the intermediate layer 123 is made of a transition metal chalcogenide, i.e., molybdenum disulfide. According to this structure in FIG. 3, the same wear resistance as in the first embodiment can be obtained, and an adhesion of the second solid lubricant film 122 is improved.

### Modifications

The present disclosure is not necessarily limited to the above embodiments. Thus, it is possible to appropriately modify the above-described embodiments. Hereinafter, representative modifications will be described. In the following descriptions of the modifications, differences from the above embodiments will be mainly described. In the above embodiments and the modifications, the same reference numerals are assigned to the same or equivalent elements. Therefore, in the following descriptions of the modifications, the descriptions in the above embodiments can be appropriately incorporated for the components having the same reference numerals as those in the above embodiments, as long as there is no technical contradiction or no special additional description.

The present disclosure is not limited to the specific applications, configurations, or structures described in the above embodiments and examples. For example, a hydrogen atmosphere, in which a sliding device 10 according to the present disclosure is used, may be only a gas atmosphere, may contain liquid such as moisture, or may be a liquid atmosphere.

There is also no particular limitation on shapes and structures of a first sliding body 11 and a second sliding body 12. In other words, for example, both the first sliding body 11 and the second sliding body 12 may be spherical or cylindrical. Alternatively, for example, both the first sliding body 11 and the second sliding body 12 may have a plate-shape. Additionally, a deposit of an undercoat film to a base member is not essential.

There are also no particular limitations on materials and the like of a first base 111 and a second base 121. For example, materials of a first solid lubricant film 112 and a second solid lubricant film 122 are not limited to molybdenum disulfide. In other words, the first solid lubricant film 112 and the second solid lubricant film 122 may be constituted of a transition metal chalcogenide other than molybdenum disulfide.

Although an entire region of the first solid lubricant film 112 having an amorphous structure is not necessarily composed of an amorphous region, a higher proportion of amorphous regions is preferable. Although there are no particular limitations, the proportion of amorphous regions is preferably 50% or more, more preferably 80% or more, and even more preferably 90% or more. Similarly, the second solid lubricant film 122 having a layered structure may be two-dimensionally oriented substantially. In other words, the second solid lubricant film 122 is not necessarily to be completely two-dimensionally oriented, and may include partially the amorphous structure.

There are also no particular limitations on a thickness or a method of deposit of the first solid lubricant film 112 and the second solid lubricant film 122. Additionally, the first solid lubricant film 112 and/or the second solid lubricant film 122 may be composed of a transition metal chalcogenide containing an additive element such as titanium. Due to addition of the additive element, hardness of the transition metal chalcogenide can be improved, and an amorphous state of the first solid lubricant film 112 can be well maintained.

The constituent element(s) of each of the above embodiments and the above modifications is/are not necessarily essential unless it is specifically stated that the constituent element(s) is/are essential in the above embodiments, or unless the constituent element(s) is/are obviously essential in principle. When numerical values such as the number, amount, and range of elements are mentioned, the present disclosure is not limited to the specific numerical values unless otherwise specified as essential or obviously limited to the specific numerical values in principle. Similarly, in the case where the shape, the direction, the positional relationship, and/or the like of the constituent element(s) is specified, the present disclosure is not necessarily limited to the shape, the direction, the positional relationship, and/or the like unless the shape, the direction, the positional relationship, and/or the like is/are indicated as essential or is/are obviously essential in principle.

The modifications are also not necessarily limited to the above examples. That is, for example, apart from the above-described examples, multiple embodiments can be combined unless there is a technical contradiction. Similarly, multiple modifications may be combined with each other unless there is a technical contradiction.

What is claimed is:

1. A sliding device comprising a first sliding body and a second sliding body, wherein
the first sliding body has a surface as a first sliding face,
the second sliding body has a surface as a second sliding face,
the first sliding face and the second sliding face are configured to slide against each other in a hydrogen atmosphere,
the first sliding body includes a first solid lubricant film forming the first sliding face,
the second sliding body includes a second solid lubricant film forming the second sliding face,
the first solid lubricant film is made of a material having an amorphous structure, and
the second solid lubricant film is made of a material having a layered structure.

2. The sliding device according to claim 1, wherein
the second solid lubricant film is made of a transition metal chalcogenide.

3. The sliding device according to claim 1, wherein
the second solid lubricant film is made of a transition metal chalcogenide containing an additive element.

4. The sliding device according to claim 1, wherein
the sliding device further includes a base, and an intermediate layer covering the base,
the second solid lubricant film covers the intermediate layer, and
the base, the intermediate layer and the second solid lubricant film form a laminated structure.

5. The sliding device according to claim 4, wherein
the intermediate layer is made of a transition metal chalcogenide.

6. The sliding device according to claim 1, wherein
a proportion of amorphous regions in the first solid lubricant film is 50% or more.

7. The sliding device according to claim 1, wherein
a proportion of amorphous regions in the first solid lubricant film is 80% or more.

8. The sliding device according to claim 1, wherein
a proportion of amorphous regions in the first solid lubricant film is 90% or more.

9. The sliding device according to claim 1, wherein
the first solid lubricant film includes a hydrogen terminated surface on the first sliding face, and
the second solid lubricant film includes an outer surface that is two-dimensionally oriented on the second sliding face.
